(19) United States
(12) Patent Application Publication
(10) Pub. No.: US 2026/0225757 A1
(43) Pub. Date: Aug. 6, 2026

(54) MARKING INSTALLATION FOR CONTAINERS MADE OF THERMOPLASTIC MATERIAL OBTAINED BY A STRETCH-BLOW MOULDING PROCESS

(71) Applicant: SIDEL PARTICIPATIONS, Octeville-sur-Mer (FR)

(72) Inventors: Guy FEUILLOLEY, OCTEVILLE- SUR-MER (FR); Véronique BERNARD, OCTEVILLE- SUR-MER (FR); Cyrille SAVARY, OCTEVILLE- SUR-MER (FR); Frédéric LECOMTE, OCTEVILLE- SUR-MER (FR); Daniel DIESNIS, OCTEVILLE- SUR-MER (FR); Guillaume CHAUVIN, OCTEVILLE- SUR-MER (FR)

(21) Appl. No.: 19/530,712

(22) Filed: Feb. 5, 2026

(30) Foreign Application Priority Data
Feb. 5, 2025 (FR) 2501192

(51) Int. Cl. B65B 61/26; B29C 71/04; B29L 31/00

(52) U.S. Cl. CPC B65B 61/26; B29C 71/04; B29L 2031/7158

(57) ABSTRACT

Provided is a marking installation for thermoplastic containers, the installation including two conveyors to convey the containers along two distinct conveying paths on two distinct packaging lines from an inlet to an outlet of each conveyor, and a plurality of laser marking devices to apply information in an information region, each marking device being positioned between the two conveyors and being configured to apply information alternately in the information region of a container of a first conveyor then in the information region of a container of the second conveyor.

### CROSS-REFERENCE TO RELATED APPLICATIONS

This application claims the benefit of French Application No. FR2501192, filed Feb. 5, 2025, the entire contents of which is hereby incorporated herein by reference.

### BACKGROUND

In the field of the manufacture of PET containers, such as bottles, it is well known for information such as the capacity, the composition of the contents of the containers, the expiry date, etc., and/or decorations such as the logo of the producer of the product, for example, to be provided on said containers. Present laser marking devices for plastic containers do not allow marking the containers at high throughputs such as rates greater than 4000 bottles per hour. It is to the provision of meeting these and other needs that the present invention is primarily directed.

### SUMMARY

Embodiments of the present disclosure provide for marking installations for marking containers made of thermoplastic material obtained by a stretch-blow moulding process.

An embodiment of the present disclosure includes a marking installation. The container can have at least a body, a shoulder extending from said body at an upper end thereof, a neck extending from the shoulder and a wall, with the wall having at least one information region. The installation can include two conveyors and a plurality of laser marking devices. The two conveyors can be configured to convey containers along two distinct conveying paths on two distinct packaging lines from an inlet to an outlet of each conveyor. The plurality of laser marking devices can be configured to apply information in said at least one information region, where each marking device can positioned between the two conveyors to apply information alternately in the information region of a container of a first conveyor then in the information region of a container of a second conveyor.

These and other aspects, objects, features, and embodiments will become apparent to a person of ordinary skill in the art upon consideration of the following detailed description of illustrative embodiments exemplifying the best mode as presently perceived.

### BRIEF DESCRIPTION OF THE DRAWINGS

Other advantages and features will become more clearly apparent from the following description of several variants of embodiment, provided by way of non-limiting examples, of the marking installation for containers made of thermoplastic material in accordance with the present disclosure, with reference to the appended drawings in which:

FIG. 1 is a schematic top view of the marking installation according to the present disclosure,

FIG. 2 is a schematic top view of the marking installation according to the present disclosure in a second step of the marking method,

FIG. 3 is a schematic top view of the marking installation according to the present disclosure in a third step of the marking method,

FIG. 4 is a schematic top view of the marking installation according to the present disclosure in a fourth and final step of the marking method,

FIG. 5 is a schematic representation of a laser marking device of the marking installation according to the present disclosure,

FIG. 6 is a schematic perspective wireframe view of the laser scanning head of the laser marking device shown in FIG. 5 of the marking installation according to the present disclosure,

FIG. 7 is a schematic perspective wireframe view of the laser scanning head of a first variant of embodiment of the laser marking device of the marking installation according to the present disclosure,

FIG. 8 is a schematic perspective wireframe view of a second variant of embodiment of the laser scanning head of the laser marking device of the marking installation according to the present disclosure, and

FIG. 9 is a schematic front view of a container, showing in particular two laser marking regions.

### TECHNICAL FIELD

The present disclosure relates to the field of containers, in particular bottles or jars, produced by blow molding or stretch blow molding from plastic preforms such as polyethylene terephthalate (PET) and/or recycled polyethylene terephthalate (rPET) and, more particularly, to a marking installation and a marking device for containers of this kind.

### PRIOR ART

In the field of the manufacture of PET containers, such as bottles, it is well known for information such as the capacity, the composition of the contents of the containers, the expiry date, etc., and/or decorations such as the logo of the producer of the product, for example, to be provided on said containers.

Usually, said information appears on paper or plastic labels that are affixed to the final container after the container forming step, or after the container filling step, in other words, when the containers have been shaped into their final form.

However, the labelling of containers has numerous drawbacks. In effect, the manufacture of the labels, their printing and their application onto the containers represent a high cost, in particular for large-scale container production. Moreover, the label is liable to be torn off during handling of the container, in which case the end user can no longer access certain important information, such as the expiry date. Finally, recycling PET containers is made more difficult by the presence of the label and the adhesive, these constituting impurities that make containers produced from recycled PET (rPET) opaque and impair their mechanical properties.

To apply important information, marking processes on the wall of the container have already been proposed. Hence, it is known in the art for certain important information to be printed directly onto the wall of the container using a special ink.

Nevertheless, this printing-type marking process is not satisfactory because, for hygiene reasons, the ink used for marking must dry almost instantaneously and it must also remain on the surface of the wall without penetrating the interior of the container by a migration phenomenon. As a result, the ink has a specific composition that is very costly to produce.

Furthermore, the use of ink also complicates the processes involved in recycling plastic containers.

To overcome these problems, a marking process has also been proposed in which the wall of the container is engraved. The engraving is generally carried out by a carbon dioxide laser. A marking process of this kind is performed by removing material from the wall of the container, in particular by evaporation. As a result, the wall has a reduced thickness locally.

However, for economic and environmental reasons, efforts are being made to reduce the thickness of the container walls. Hence, it is possible to produce a container using less plastic material than before. The removal of material from a very thin wall risks weakening the wall to such an extent that the container may burst under the slightest stress.

Other known laser marking devices exhibit quality problems when used on articles or substrates that are not flat and/or that have a variable focal distance relative to the optics, as is the case for a large majority of containers.

In such a case, the markings on the substrate are blurred, vary in height or spacing and may even be illegible, thereby rendering the characters unsatisfactory for use.

To avoid this problem, it is often necessary to stop the movement of the container to be marked, which directly affects the operating rate of the industrial line.

In this respect, laser marking installations for containers made of thermoplastic material obtained by a stretch-blow molding process, in particular bottles or flasks, have already been proposed. This is the case, in particular, in documents EP2380693, EP2983106, FR2907370 and CN116275544.

Document EP2380693 describes a system for marking an object, such as a container, in motion by means of a laser which comprises a laser system with a laser beam capable of marking within a working area, with a controller, a drive system capable of moving the object to be marked with a speed controller, and a sensor system for determining the position of the object to be marked, the laser system and the sensor system being connected in such a manner that the controller for the laser system has an input signal corresponding to a position signal originating from the sensor system. The laser system and the drive system are connected in such a manner that the speed controller for the drive system receives a speed variation signal from the controller for the laser system, this speed variation signal being a function of the position signal received by the laser system relative to the working area and of the position of the laser beam within the working area.

Document EP2983106 describes a method and a system for printing information on a container. The method consists of providing a printing system having a laser source intended to produce a printing beam and of directing said beam towards several locations on a material, and/or of setting a dwell time of the printing beam at at least one location, so as to form a mark at each location. The method may also consist of providing a printing system intended to print a code on a product moving in one direction, and/or of printing the code as a function of a set of corrected data. The system comprises a laser designed to produce a printing beam, the laser having a maximum power of 25 watts, and a housing comprising a printing-beam outlet element through which said beam exits the housing. The system further comprises, inside the housing, an optical assembly which makes it possible to focus the printing beam on a product adjacent to the housing.

Document FR2907370 describes a marking installation, at the outlet of a forming machine, transparent or translucent articles which pass in translation successively in front of a marking station comprising an apparatus for producing a laser beam, in order to ensure marking of the articles. Said installation comprises means for determining the position of each article in at least one direction transverse to the direction in which the articles advance, these means being arranged upstream of the marking station in the direction of advance, means for displacing the focal plane of the laser beam in a direction transverse to the direction of advance, and control means for the displacement means, connected to the position-determining means and configured to adapt, as a function of the position of each article to be marked, the focal plane of the laser beam, so as to optimize the marking of the articles by the laser beam.

Document CN116275544 describes a batch laser marking system for plastic bottle bodies that comprises a first screw-type conveying device, a first bottle gripping and conveying device, a first finished-product conveying device and a network of flying laser marking devices. The network of flying laser marking devices comprises multiple flying laser marking devices; a laser marking station is arranged in front of a laser scanning head of each flying laser marking device, and the first bottle gripping and conveying device grips the openings of plastic bottles arranged at equal intervals and conveys the bottle openings to the corresponding laser marking stations of the network of flying laser marking devices. The network of flying laser marking devices performs laser marking and patterning on the plastic bottle bodies arranged at equal intervals, and the first bottle gripping and conveying device grips the plastic bottle bodies subjected to the laser marking and conveys them to the first finished-product conveying device, in order to transport them to the next production station.

However, all of these laser marking devices for plastic containers have the drawback that they do not allow marking of the containers at high throughputs, that is to say at rates greater than 4000 bottles per hour.

### DETAILED DESCRIPTION

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

The following examples are put forth so as to provide those of ordinary skill in the art with a complete disclosure and description of how to perform the methods and use the devices and methods disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, manufacturing processes, or the like, as such can vary. It is also to be understood that the terminology used herein is for purposes of describing particular embodiments only and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise.

The features, structures, or characteristics described above may be combined in one or more embodiments in any suitable manner, and the features discussed in the various embodiments may be interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

The terms used herein are intended to have their ordinary meaning unless specifically defined otherwise. Directional terms such as “upper,” “lower,” “front,” “back,” and similar terms are used for convenience and are not intended to be limiting unless the context clearly indicates otherwise. The use of “may,” “can,” “could,” and similar terms indicates possible embodiments and is not intended to limit the scope of the disclosure.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims.

The terms “first,” “second,” etc. are used only as labels, rather than a limitation for a number of the objects. It is understood that if multiple components are shown, the components may be referred to as a “first” component, a “second” component, and so forth, to the extent applicable.

One aim of the present disclosure is therefore to correct some or all of these drawbacks by proposing a marking installation for plastic containers of simple and inexpensive design, allowing information to be printed on the containers at high throughputs.

To this end, and according to the present disclosure, there is proposed a marking installation for containers made of thermoplastic material obtained by a stretch-blow molding process, in particular bottles or flasks, said container comprising at least a body, a shoulder extending from said body at an upper end thereof, a neck extending from the shoulder, and a wall, said wall comprising at least one region referred to as an information region. Said installation is characterised in that it comprises at least two conveyors configured to convey said containers along two distinct circulation paths on two distinct packaging lines from an inlet to an outlet of each conveyor, and a plurality of laser marking devices configured to apply information in said at least one information region, referred to as the laser marking region of a container, each marking device being positioned between the two conveyors and being configured to apply information alternately in the laser marking region of a container of a first conveyor then in the laser marking region of a container of the second conveyor.

Preferably, each conveyor consists of a stepwise-driven motorized belt conveyor.

Furthermore, said two conveyors are arranged parallel to one another in such a manner that the circulation paths of the containers on said conveyors have the same direction of travel.

In addition, the pitch of each belt conveyor is substantially equal to the distance separating four containers conveyed by said conveyor.

Advantageously, the first belt conveyor is advanced by one pitch when the second belt conveyor is at a standstill, and vice versa.

Furthermore, said installation preferably comprises at least four marking devices configured to emit a laser beam in two opposite directions, said marking devices being fixedly positioned equidistant from the two conveyors, i.e. along a median line parallel to the circulation paths of the conveyors.

Said marking devices are arranged on said median line equidistant from one another.

According to a first embodiment, each marking device comprises at least one laser source, a multichannel beam switch having an inlet for the laser beam emitted by the laser source and two outlets for a laser beam, and two laser scanning heads consisting of a housing comprising a laser entry window configured to receive the laser beam emitted by one of the outlets of the multichannel beam switch, at least one galvanometric mirror mounted on the rotation shaft of a drive motor for rotating said galvanometric mirror, and an outlet window through which the marking laser beam is emitted.

According to a second embodiment, each marking device comprises at least one laser source and a laser scanning head consisting of a housing comprising a laser entry window configured to receive the laser beam emitted by the laser source, at least one galvanometric mirror mounted on the rotation shaft of a drive motor for rotating said galvanometric mirror in rotation, and two opposite outlet windows through which the marking laser beam is emitted alternately through a first outlet window and a second outlet window.

Said housing of each laser scanning head is substantially parallelepipedal, one of the walls comprising the entry window and two opposite walls respectively comprising an outlet window.

Furthermore, each scanning head comprises a first galvanometric mirror extending in line with the entry window and secured to the output shaft of a first electric motor, said first galvanometric mirror being configured to reflect the laser beam passing through the entry window towards a second galvanometric mirror, referred to as a distributor, which extends in line with the outlet windows and is secured to the output shaft of a second electric motor, the output shaft of the second electric motor being orthogonal to the output shaft of the first electric motor.

Alternatively, each scanning head comprises a first galvanometric mirror extending in line with the entry window and secured to the output shaft of a first electric motor, said first galvanometric mirror being configured to reflect the laser beam passing through the entry window towards a second galvanometric mirror, referred to as a distributor, which is secured to the output shaft of a second electric motor, the output shaft of the second electric motor being orthogonal to the output shaft of the first electric motor, said second galvanometric distributor mirror reflecting the laser beam alternately onto a third and a fourth galvanometric mirror extending respectively in line with the outlet windows, the third and fourth galvanometric mirrors being secured to the output shaft of a third electric motor and of a fourth electric motor, respectively.

Furthermore, the output shafts of the second electric motor, the third electric motor and the fourth electric motor extend in parallel.

### EXAMPLES

In the remainder of the description, elements having an identical structure or analogous functions will be designated by the same reference sign.

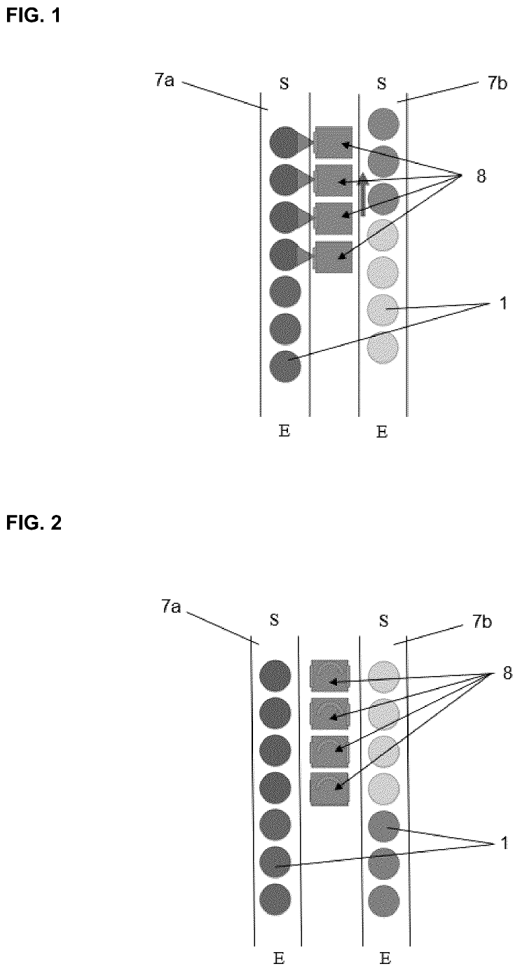

With reference to FIG. 1, an installation will be described below for marking containers 1 made of thermoplastic material obtained by a stretch-blow molding process, in particular bottles or flasks, from a plastic preform such as polyethylene terephthalate (PET) and/or recycled polyethylene terephthalate (rPET) or similar, said container 1 comprising, with reference to FIG. 9, at least a body 2, a shoulder 3 extending from said body 2 at an upper end thereof, a neck 4 extending from the shoulder 3, said neck receiving a closure, and a wall 5, said wall comprising two regions 6 referred to as information regions. In this particular example, said wall 5 comprises two information regions 6; however, it is clearly understood that said wall 5 of the container 1 may comprise only one information region 6 or more than two information regions 6 without thereby departing from the scope of the present disclosure.

Furthermore, with reference to FIG. 1, said installation comprises at least two conveyors 7a, 7b configured to convey said containers 1 along two distinct circulation paths on two distinct packaging lines from an inlet (E) to an outlet (S) of each conveyor 7a, 7b, and a plurality of laser marking devices 8 configured to apply information in said at least one information region 6 of the containers 1, referred to as the laser marking region of a container, each marking device being positioned between the two conveyors 7a, 7b and being configured to apply information alternately in the laser marking region of a container 1 of a first conveyor 7a, then in the laser marking region of a container 1 of the second conveyor 7b. Each conveyor 7a, 7b consists of a stepwise-driven motorized belt conveyor.

It is clear that the belt conveyors 7a, 7b may be replaced by any other equivalent conveying device, such as a gripper conveyor that grips the containers 1 at the neck or similar, well known to a person skilled in the art, without thereby departing from the scope of the present disclosure.

Said conveyors 7a, 7b respectively comprise a device for spacing the containers 1, so that each container is presented opposite each laser marking device 8.

Furthermore, the aforementioned two conveyors 7a, 7b are arranged parallel to one another in such a manner that the circulation paths of the containers 1 on said conveyors 7a, 7b have the same direction of travel. The pitch of each belt conveyor 7a, 7b is substantially equal to the distance separating four containers 1 conveyed by said conveyor 7a, 7b. As will be explained in greater detail below, the first belt conveyor 7a is advanced by one pitch when the second belt conveyor 7b is at a standstill, and vice versa.

Advantageously, said conveyors 7a, 7b may comprise a device for adjusting their position relative to the laser marking devices 8, in order to present the containers 1 at the desired focal distance. In fact, in the event that containers of different diameters can be marked on the same installation, this focal distance may need to be adjusted between production runs.

Moreover, in this particular embodiment, said installation comprises four marking devices 8 configured to emit laser radiation in two opposite directions, said marking devices 8 being fixedly positioned equidistant from the two conveyors 7a, 7b, i.e. along a median line parallel to the circulation paths of the conveyors 7a, 7b, said marking devices 8 being described in greater detail below. Said marking devices 8 are arranged on said median line equidistant from one another, with substantially the same spacing as between the containers 1 conveyed by the conveyors 7a, 7b.

It will be observed that the installation may comprise more or fewer than four marking devices 8 without thereby departing from the scope of the present disclosure; however, it should be noted that high production throughputs can be achieved using only four marking devices 8.

Hence, with reference to FIG. 1, four containers 1 of a first conveyor 7a are positioned in line with the four marking devices 8 of the installation, each laser marking device 8 then applying a marking in the one or more information region(s) 6 of each container 1 of the first conveyor 7a for a duration of approximately 3 seconds, the marking laser beam of said marking devices 8 being directed towards said first conveyor 7a.

After this marking operation on the containers 1 of the first conveyor 7a, and with reference to FIG. 2, the marking direction of the marking devices 8 is changed in such a manner that the marking laser beam of the marking devices 8 is oriented in the opposite direction, that is to say towards the second conveyor 7b on which the containers 1 are positioned in line with said marking devices 8. The time required to change the marking direction of the marking devices 8 is approximately 0.1 seconds.

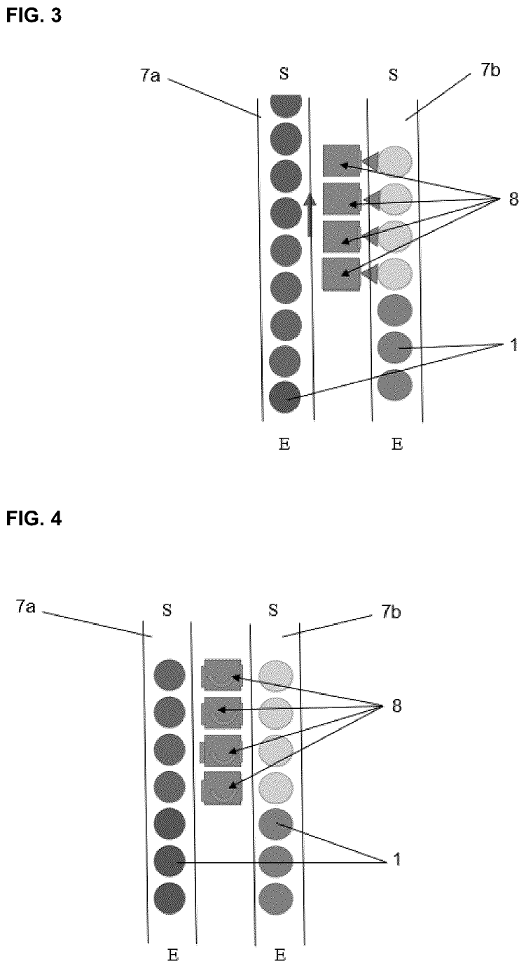

With reference to FIG. 3, when the four containers 1 of the second conveyor 7b are positioned in line with the four marking devices 8 of the installation, each laser marking device 8 then applies a marking in the one or more regions 6 referred to as information regions of each container 1 of the second conveyor 7b for a duration of approximately 3 seconds, the marking laser beam of said marking devices 8 being directed towards said second conveyor 7b. At the same time, the first conveyor 7a is advanced by one pitch, in order to convey the four marked containers 1 out of the marking zone of the marking devices 8 and to position four new containers 1 of the first conveyor 7a opposite the marking devices 8.

After this marking operation on the containers 1 of the second conveyor 7b, with reference to FIG. 4, the marking direction of the marking devices 8 is changed in such a manner that the marking laser beam of the marking devices 8 is oriented in the opposite direction, that is to say again towards the first conveyor 7a on which the containers 1 extend in line with said marking devices 8. The time required to change the marking direction of the marking devices 8 is likewise approximately 0.1 seconds.

The containers 1 of the first conveyor 7a are then marked by the marking devices 8, with reference to FIG. 1, while the marked containers 1 of the second conveyor 7b are moved by advancing said second conveyor 7b by one pitch in a new cycle, the duration of one cycle being in the order of 6.2 seconds, in such a manner that the installation according to the present disclosure allows the marking of approximately 4600 containers per hour.

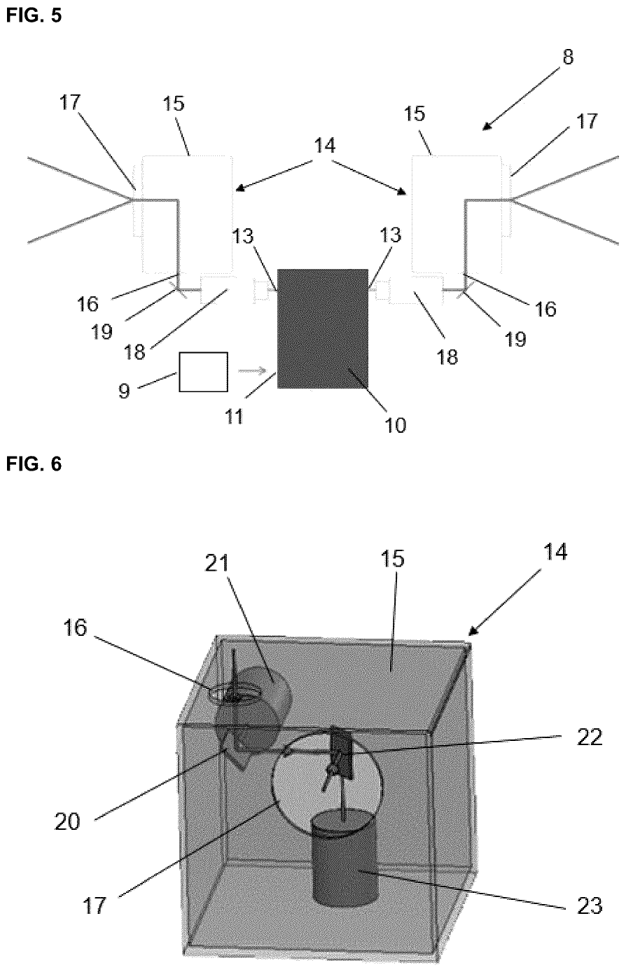

According to a first embodiment, with reference to FIG. 5, each marking device 8 comprises at least one laser source 9, a multichannel beam switch 10 comprising an inlet 11 for the laser beam 12 emitted by the laser source 9 and two outlets 13 for a laser beam and two laser scanning heads 14 mounted head-to-tail and consisting of a housing 15 comprising a laser entry window 16 configured to receive the laser beam emitted by one of the outlets 13 of the multichannel beam switch 10 and an outlet window 17 through which the marking laser beam is emitted.

In this particular embodiment, the marking device 8 comprises, between the outlets 13 of the multichannel beam switch 10 and the laser scanning heads 14, an optical component 18 configured to dynamically recentre the laser beam at the outlet 13 of the multichannel beam switch 10, said optical component 18 comprising a linearly movable lens for this purpose. Optionally, a galvanometric mirror 19 is arranged between the outlet of said optical component 18 and the entry window 16 of the laser scanning head 14.

Furthermore, with reference to FIG. 6, in this first embodiment shown in FIG. 5, each laser scanning head 14 consists of a housing 15 comprising, on its upper face, a laser entry window 16 configured to receive the laser beam emitted by one of the outlets 13 of the multichannel beam switch 10, and an outlet window 17 through which the marking laser beam is emitted. Furthermore, inside said housing 15, the laser scanning head 14 comprises at least a first galvanometric mirror 20 mounted on the rotation shaft of a first drive motor 21 for rotating said first galvanometric mirror 20, said first galvanometric mirror 20 extending in line with the entry window 16, and the rotation shaft of the first drive motor 21 extending substantially horizontally. Said scanning head 14 also comprises a second galvanometric mirror 22 mounted on the rotation shaft of a second drive motor 23 for rotating said second galvanometric mirror 22, said second galvanometric mirror 22 extending in line with the outlet window 17 of the housing 15 and with the first galvanometric mirror 20, and the rotation shaft of the second drive motor 23 extending substantially vertically, in such a manner that the las marking beam emerging from the outlet window 17 can be scanned in a vertical plane and/or in a horizontal plane by actuating the first drive motor 21 and/or the second drive motor 23 associated with the galvanometric mirrors 20 and 22, respectively. It should be noted that the outlet window 17 may comprise an optical lens which is not shown in the figures.

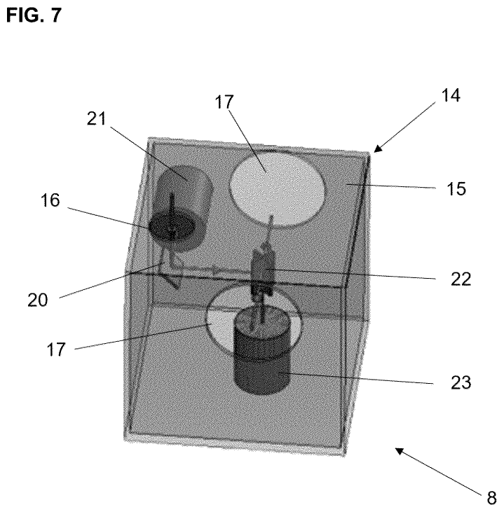

According to a second embodiment, with reference to FIG. 7, each marking device comprises at least one laser source, not shown in FIG. 7, and a laser scanning head 14 consisting of a housing 15 comprising, on its upper face, a laser entry window 16 configured to receive the laser beam emitted by the laser source, at least a first galvanometric mirror 20 mounted on the rotation shaft of a first drive motor 21 for rotating said galvanometric mirror 20, and two opposite outlet windows 17 through which the marking laser beam is emitted alternately through a first outlet window 17 and a second outlet window 17.

The aforementioned housing 15 of each laser scanning head 14 is substantially parallelepipedal, one of the walls, in this case the upper wall of the housing 15, comprising the entry window 16, and two other opposite walls, in this case two lateral walls, respectively comprising an outlet window 17. It should be noted that the outlet windows 17 may comprise an optical lens, not shown in FIG. 7.

Furthermore, each laser scanning head 14 comprises a first galvanometric mirror 20 extending opposite the entry window 16 and secured to the output shaft of a first electric motor 21, said first galvanometric mirror 20 being configured to reflect the laser beam passing through the entry window 16 towards a second galvanometric mirror 22, referred to as a distributor, extending in line with the outlet windows 17 and secured to the output shaft of a second electric motor 23, the output shaft of the second electric motor 23 being orthogonal to the output shaft of the first electric motor 21, which extends substantially horizontally.

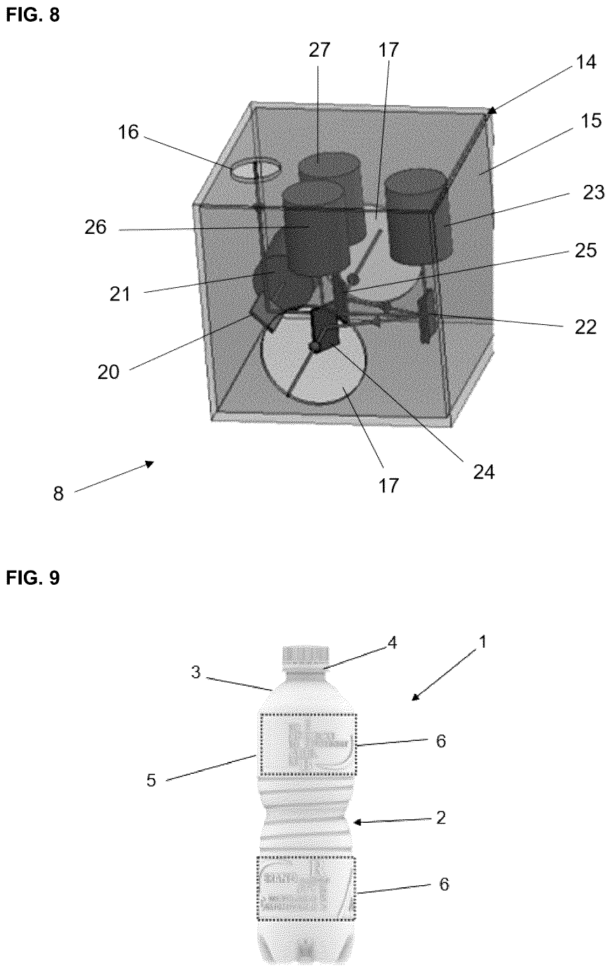

According to another embodiment, with reference to FIG. 8, each laser scanning head 14 comprises, in the same manner as previously, at least one laser source, not shown in FIG. 8, and a laser scanning head 14 consisting of a housing 15 comprising, on its upper face, a laser entry window 16 configured to receive the laser beam emitted by the laser source, at least a first galvanometric mirror 20 mounted on the rotation shaft of a first drive motor 21 for rotating said galvanometric mirror 20, and two opposite outlet windows 17 through which the marking laser beam is emitted alternately through a first outlet window 17 and a second outlet window 17.

The aforementioned housing 15 of each laser scanning head 14 is substantially parallelepipedal, one of the walls, in this case the upper wall of the housing 15, comprising the entry window 16, and two other opposite walls, in this case two lateral walls, respectively comprising an outlet window 17. It should be noted that the outlet windows 17 may comprise an optical lens, not shown in FIG. 7.

Each laser scanning head 14 comprises a first galvanometric mirror 20 extending opposite the entry window 16 and secured to the output shaft of a first electric motor 21, said first galvanometric mirror 20 being configured to reflect the laser beam passing through the entry window 16 towards a second galvanometric mirror 22, referred to as a distributor, secured to the output shaft of a second electric motor 23, the output shaft of the second electric motor 23 being orthogonal to the output shaft of the first electric motor 21, which extends substantially horizontally. Said second galvanometric distributor mirror 22 reflects the laser beam alternately onto a third galvanometric mirror 24 and a fourth galvanometric mirror 25 extending respectively opposite the outlet windows 17, the third mirror 24 and the fourth mirror 25 being secured to the output shaft of a third electric motor 26 and of a fourth electric motor 27 respectively. The output shafts of the second electric motor 23, the third electric motor 26 and the fourth electric motor 27 extend parallel to one another and vertically.

Finally, it is clearly understood that the examples which have just been described are only particular, in no way limiting, illustrations as to the fields of application of the present disclosure.

Therefore, at least the following is claimed:

1. A marking installation for containers made of thermoplastic material obtained by a stretch-blow moulding process, said container comprising at least a body, a shoulder extending from said body at an upper end thereof, a neck extending from the shoulder and a wall, said wall comprising at least one information region, wherein said installation comprises at least:
two conveyors configured to convey said containers along two distinct conveying paths on two distinct packaging lines from an inlet to an outlet of each conveyor; and
a plurality of laser marking devices configured to apply information in said at least one information region, each marking device being positioned between the two conveyors and being configured to apply information alternately in the information region of a container of a first conveyor then in the information region of a container of a second conveyor.

2. The marking installation for containers according to claim 1, wherein each conveyor consists of a stepwise-driven motorized belt conveyor.

3. The marking installation for containers according to claim 2, wherein the two conveyors are arranged parallel to one another in such a manner that circulation paths of the containers on said conveyors have the same direction of travel.

4. The marking installation for containers according to claim 2, wherein a pitch of each belt conveyor is substantially equal to a distance separating four containers conveyed by said conveyor.

5. The marking installation for containers according to claim 2, wherein the first belt conveyor is advanced by one pitch when the second belt conveyor is at a standstill, and vice versa.

6. The marking installation for containers according to claim 1, wherein the installation comprises at least four marking devices configured to emit a laser beam in two opposite directions, said marking devices being fixedly positioned equidistant from the two conveyors along a median line parallel to the circulation paths of the conveyors.

7. The marking installation for containers according to claim 6, wherein said marking devices are arranged on said median line equidistant from one another.

8. The marking installation for containers according to claim 1, wherein each marking device comprises at least one laser source, a multi-channel beam switch having an inlet for the laser beam emitted by the laser source and two outlets for a laser beam, and two laser scanning heads comprising a housing, the housing comprising a laser entry window configured to receive the laser beam emitted by one of the outlets of the multi-channel beam switch, at least one galvanometric mirror mounted on the rotation shaft of a drive motor for rotating said galvanometric mirror, and an outlet window through which the marking laser beam is emitted.

9. The marking installation for containers according to claim 1, wherein each marking device comprises at least one laser source and a laser scanning head comprising a housing comprising a laser entry window configured to receive a laser beam emitted by the laser source, at least one galvanometric mirror mounted on the rotation shaft of a drive motor for rotating said galvanometric mirror in rotation, and two opposite outlet windows through which the marking laser beam is emitted alternately through a first outlet window and a second outlet window.

10. The marking installation for containers according to claim 9, wherein the housing of each laser scanning head is substantially parallelepipedal, having one wall comprising an entry window and two opposite walls respectively comprising an outlet window.

11. The marking installation for containers according to claim 10, wherein each scanning head comprises a first galvanometric mirror extending in line with the entry window and secured to the output shaft of a first electric motor, said first galvanometric mirror being configured to reflect the laser beam passing through the entry window towards a second galvanometric mirror, referred to as a distributor, which extends in line with the outlet windows and is secured to the output shaft of a second electric motor, the output shaft of the second electric motor being orthogonal to the output shaft of the first electric motor.

12. The marking installation for containers according to claim 10, wherein each scanning head comprises a first galvanometric mirror extending in line with the entry window and secured to an output shaft of a first electric motor, said first galvanometric mirror being configured to reflect the laser beam passing through the entry window towards a second galvanometric mirror which is secured to the output shaft of a second electric motor, the output shaft of the second electric motor being orthogonal to the output shaft of the first electric motor, said second galvanometric mirror reflecting the laser beam alternately onto a third and a fourth galvanometric mirror extending respectively in line with the outlet windows, the third and fourth galvanometric mirrors being secured to the output shaft of a third electric motor and of a fourth electric motor, respectively.

13. The marking installation for containers according to claim 12, wherein output shafts of the second electric motor, the third electric motor and the fourth electric motor extend in parallel.

14. The marking installation for containers according to claim 8, wherein the housing of each laser scanning head is substantially parallelepipedal, having one wall comprising an entry window and two opposite walls respectively comprising an outlet window.
